(19) United States
(12) Patent Application Publication
(10) Pub. No.: US 2011/0151252 A1
(43) Pub. Date: Jun. 23, 2011

(54) ADHESIVE TAPE OR SHEET

(75) Inventors: Toshio Shintani, Ibaraki-shi (JP); Akiyoshi Yamamoto, Ibaraki-shi (JP); Tsubasa Miki, Ibaraki-shi (JP)

(73) Assignee: NITTO DENKO CORPORATION, Ibaraki-shi, Osaka (JP)

(21) Appl. No.: 13/061,011

(22) PCT Filed: Aug. 20, 2009
(86) PCT No.: PCT/JP2009/064559

§ 371 Date: Feb. 25, 2011

(30) Foreign Application Priority Data
Aug. 27, 2008 (JP) 2008-217502

(51) Int. Cl. C09J 133/08

(52) U.S. Cl. 428/355 AC; 524/523

(57) ABSTRACT

An adhesive tape or sheet comprises an adhesive layer which contains 0.3 to 10 parts by weight of an polyether polyol compound, and 0.005 to 2 parts by weight of at least one alkali metal salt for 100 parts by weight of an acrylic adhesive which is formed with a copolymer of methyl acrylate monomer, ethyl acrylate monomer, or methyl acrylate monomer and ethyl acrylate monomer, acrylate monomer, and 2-ethylhexyl acrylate monomer.

### TECHNICAL FIELD

The present invention relates to an adhesive tape or sheet, and more particularly, relates to an adhesive tape or sheet provided with a base and an adhesive layer, and suitably used in processing of a semiconductor wafer and/or a substrate.

### BACKGROUND ART

Typically, an adhesive sheet having a base coated with an adhesive layer that undergoes polymerization and curing through electron beams has been used as a processing sheet for a semiconductor wafer or the like when dicing, expanding, and the like are executed while adhering to the semiconductor wafer and/or substrate. Picking up and mounting of these semiconductor wafers or the like are then executed. When using such an adhesive sheet, after dicing, the adhesive layer is polymerized and cured by irradiation of electron beams onto the adhesive layer. The adhesive force is thereby reduced and, therefore, pick-up of the semiconductor wafer (chip) or the like can be facilitated.

An example of this type of adhesive sheets has been proposed which includes a sheet that has a base and an adhesive layer (for example, Patent Document 1 and 2). These sheets are formed in a way that the adhesive layers include a base polymer, a multifunctional urethane-acrylate oligomer having a predetermined molecular weight, a polyester plasticizer, and a photo-polymerization initiator.

However, in recent years, an increasing number of wafers include printing marks produced by laser irradiation at a depth of about 5 to 10 μm on the wafer surface. Furthermore, semiconductor devices increasingly include a rough surface of about 0.4 to 15 μm on a sealed resin surface that forms the adhesive tape adhesion surface, and include printing marks having a depth of about 25 to 40 μm in the same manner as wafers.

When dicing a semiconductor wafer or the like that includes an unevenness as described above, the above type of adhesive sheet does not result in a sufficient adhesive force because of its insufficiency in adapting (following) to the unevenness of the adhesion surface. As a result, wafer or the like is broken free (flying wafer) during dicing, and results in a disadvantage of a large decrease in productivity. Also, in the event that a flying wafer collides with a cutting blade, damages may occur to the blade.

Furthermore, regardless of the presence or absence of unevenness, it has been proposed to add a tackifier to the adhesive in order to avoid flying chip during dicing (for example, Patent Document 3). This tackifier improves the adhesive force by adjusting a hydroxyl value, which is induced using a 7.1 neutralization titration method according to JIS K0070-1992, to 50 to 150 KOHmg/g, to thereby prevent flying PKG.

On the other hand, in recent years, in line with product development that takes environmental concerns into consideration, a sealing resin may include, as additives, a stabilizer formed from a metal soap that differs from conventionally applied types, and dehalogenation fire retardants. In line with this trend, types and compositions of resins that are different from conventional types are used in order to maintain characteristics of the sealing resin.

Therefore, due to such changes described above in the sealing resin or the like used on semiconductor devices or the like, which is the object for attachment, new disadvantage has been discovered that flying chip during cutting cannot be completely prevented only by use of the specific tackifier as proposed by Patent Document 3.

Furthermore, when the type of sealing resin and/or additive on the object for attachment is not appropriate, or there is an insufficient amount or inconsistent amount of die-release agent (for example, wax) generally coated on the sealing resin surface, the adhesive force on the adhesive layer will not reduce to a predetermined value upon ultraviolet irradiation. Thus, the pieces may not be picked up during the pick-up step. If the pick-up is applied by force, it will result in peeling off from the inside of sealing resin and glue residue on the whole sealing resin surface.

Moreover, due to recent advances in the miniaturization of semiconductor substrate wiring, the dielectric strength of substrates has been decreasing, which then results in more circuit failure in the substrates or product defects resulted from static electricity or electrostatic charge caused by peeling during the operation.

In this regard, an adhesive sheet processed to be antistatic has been proposed (for example Patent Document 4).

[Patent Document 1] JP H6-49420-A

[Patent Document 2] JP S62-153376-A

[Patent Document 3] JP 2005-229040-A

[Patent Document 4] JP H6-128539-A

### DISCLOSURE OF THE INVENTION

### Problem to be Solved

This adhesive sheet has a good antistatic property, but it does not always satisfy all characteristics with respect to flying chip during dicing or operational performance and adhesive residue during pick-up.

Therefore, an adhesive sheet having good characteristics with respect to flying chip during dicing and operational performance and adhesive residue during pick-up has been demanded.

It is an object of the present invention to provide an adhesive tape or sheet having good characteristics with respect to all of antistatic property, flying chip during dicing, and operational performance and adhesive residue during pick-up.

### Means for Solving the Problem

An adhesive tape or sheet of the present invention is characterized in that the adhesive tape or sheet comprises an adhesive layer which contains

0.3 to 10 parts by weight of an polyether polyol compound, and

0.005 to 2 parts by weight of at least one alkali metal salt

for 100 parts by weight of an acrylic adhesive which is formed with a copolymer of

methyl acrylate monomer, ethyl acrylate monomer, or methyl acrylate monomer and ethyl acrylate monomer,

acrylate monomer, and

2-ethylhexyl acrylate monomer.

According to the adhesive tape or sheet, it is preferred that the adhesive layer is formed on a base having the transmissivity with respect to ultraviolet light and/or radioactive rays, and further contains at least one ultraviolet-curing oligomer.

It is preferred that the adhesive layer contains a tackifier having a hydroxyl value of 120 to 230 KOH mg/g.

Also, it is preferred that the base in contact with the adhesive layer is processed with an electrostatic prevention processing.

Further, it is preferred that the adhesive tape or sheet is used in an application for a semiconductor wafer or substrate processing.

Still further, it is preferred that the polyether polyol compound has a weight-average molecular weight of 4000 or less.

Moreover, it is preferred that the alkali metal salt is a combination of at least one respective ion selected from a cation comprising of Li, Na, K, Mg, Ca, and an anion comprising of Cl, Br, I, BF₄, PF₆, ClO₄, NO₃, CO₃.

### Effect of the Invention

The adhesive tape or sheet of the present invention ensures prevention of flying wafer or the like during dicing of a semiconductor wafer or the like. Furthermore, no glue residue is will remain and the operational efficiency can be improved during the pick-up step after irradiation with electron beams. In addition, circuit failure, product defects and the like that occur in a semiconductor wafer and the like as a result of static electricity or electrostatic charge caused by peeling during the operation can be reduced.

### DETAILED DESCRIPTION OF THE PREFERRED EMBODIMENTS

The adhesive tape or sheet according to the present invention has a predetermined adhesive layer.

The adhesive layer is generally formed by including an acrylic adhesive, a polyether polyol compound, and an alkali metal salt.

The acrylic adhesive is formed by

(1) a copolymer of methyl acrylate monomer, acrylate monomer, and 2-ethylhexyl acrylate monomer;

(2) a copolymer of ethyl acrylate monomer, acrylate monomer, and 2-ethylhexyl acrylate monomer; or

(3) a copolymer of methyl acrylate monomer, ethyl acrylate monomer, acrylate monomer, and 2-ethylhexyl acrylate monomer.

The inclusion of this type of copolymer in the adhesive allows the adhesive to satisfy all characteristics that have not been realized even though there has been a long-standing demand for electrostatic prevention, suppression of flying chip during dicing, improvement of operational performance and reduction of adhesive residue during pick-up. In other words, it is possible for the adhesive layer to strongly adhere to a body to be adhered, ensure reduction of the adhesive force at an appropriate time, and always ensure an appropriate adhesive force. Moreover, a sufficient amount of component for electrostatic prevention is included so as to ensure electrostatic prevention. Then, by ensuring good compatibility between all components constituting the adhesive layer, problems such as non-homogeneity, separation, deviation, or the like of the components in the adhesive layer can be eliminated to thereby achieve a homogenous mixture and uniform distribution thereof. Therefore, individual characteristics of each component may be maximized.

The copolymer is, for example, a methyl acrylate monomer and/or an ethyl acrylate monomer: an acrylate monomer: a 2-ethylhexyl acrylate: suitably polymerized in a proportion of 40 to 70:0.5 to 20:30 to 60, and preferably 45 to 75:1 to 15:30 to 50. Within this range, even when additives are added to constitute the adhesive layer, the compatibility therewith can be ensured. Even during long-term adhesion, it is possible to prevent fluctuation in the adhesive force, or an increase in the adhesive force due to the effect of heat, or the like. In addition, an adhesive layer can be formed with sufficient strength in relation to stress, and enables prevention of problems such as adhesive residue during the pick-up step.

The molecular weight of the copolymer is preferably, for example, 300,000 to 1,500,000, and more preferably, 500,000 to 1,200,000. Within this range, the adhesive layer has sufficient strength in relation to stress after irradiated with ultraviolet rays, and the like. As a result, it is possible to prevent problems such as adhesive residue during the pick-up step. Furthermore, even when additives are added to constitute the adhesive layer, compatibility with the additives can be ensured, and stable characteristics can be obtained in relation to adhesive force, electrostatic prevention, and the like.

The polyether polyol compound includes ether linkages in the polymer molecules that generally form complexes with an alkali metal, and conducts electricity with this type of structure. Examples of the polymer molecules include, for example, polyoxyethylene glycol, polyoxy propylene glycol, and a block copolymer of polyoxyethylene glycol and polyoxy propylene glycol.

There is no particular limitation on the polyether polyol compound and any known compound may be used. For example, conductivity-imparting agent and the like described in JP 2007-70420-A and the like can be used. In particular, examples thereof include SANNIX PP-400, PP-1000, PP-2000, GP-400, GP-600, TP-400, and the like (trade name, manufactured by Sanyo chemical industries).

A polyether polyol compound having a weight-average molecular weight of 4000 or less is suitable, with 200 to 1000 being preferred. Thereby crystallization of the alkali metal salts over time in the acrylic adhesive can be suppressed, and it is possible to prevent an increase in the surface intrinsic resistivity value of the adhesive and thereby enable the manufacture of a stable adhesive tape.

The polyether polyol compound is preferably present in 0.3 parts by weight or more and 10 parts by weight or less, more preferably 0.3 parts by weight or more and 7 parts by weight or less, still more preferably 0.45 parts by weight or more and less than 7 parts by weight, further 0.45 parts by weight or more and 6 parts by weight or less, 0.45 parts by weight or more and 5 parts by weight or less, relative to 100 parts by weight of the above acrylic adhesive. This is because that the surface intrinsic resistivity value of the acrylic adhesive surface can be reduced, and that a sufficient electrostatic prevention property can be established. Furthermore, the compatibility with all components constituting the adhesive can be ensured and segregation of each component can be effectively prevented. In this manner, as an adhesive tape, a reduction in adhesive properties can be prevented, and the adhesive performance can be improved.

The alkali metal salts may be a combination of at least one respective ion selected from a cation comprising of Li, Na, K, Mg, Ca, and an anion comprising of Cl, Br, I, BF₄, PF₆, ClO₄, NO₃ and CO₃. In particular, LiClO₄ is preferably used due to its excellent ion conductivity and excellent electrostatic prevention characteristics.

The alkali metal salts are preferably present in 0.005 to 2 parts by weight, more preferably 0.005 to 1.8 parts by weight, still more preferably 0.005 to 1.5 parts by weight, 0.05 to 1.2 parts by weight, further 0.03 to 1.0 parts by weight, relative to 100 parts by weight of the acrylic adhesive. By having the alkali metal salts within this range, the surface intrinsic resistivity value of the adhesive can be reduced, and a sufficient electrostatic prevention property can be established. Furthermore, crystallization of the alkali metal salts in the acrylic adhesive can be prevented during storage, and stable characteristics can be ensured.

It is preferred that the adhesive layer in the adhesive tape or sheet according to the present invention further includes an ultraviolet-curing oligomer. The ultraviolet-curing oligomer is not particularly limited as long as it is an oligomer that can be cured through an irradiation of ultraviolet light, and any oligomer may be used. For example, such an oligomer preferably has a molecular weight of about 500 to 50,000, and more preferably about 1,000 to 30,000. By having the molecular weight within this range, the strength in the adhesive after irradiation with ultraviolet rays can be ensured. As a result, adhesion of the adhesive to the chip during operations, such as during the pick-up operation, can be prevented. Furthermore, compatibility with various components that constitute the adhesive layer can be ensured, and the stability of the adhesive force and electrostatic prevention characteristics or the like may be ensured.

The oligomer may need just, for example, two or more carbon-carbon double bonds in a molecule, examples thereof include an urethane, an urethane (meth)acrylate, a polyether, polyester, polycarbonate, polybutadiene, and other oligomers. Among these, the urethane acrylate oligomer is preferable from the point of view of flexibility or the like of the adhesive layer after irradiation with ultraviolet rays. A mixture of two or more oligomers may also be used.

In particular, it is preferred that a urethane (meth)acrylate oligomer includes 2 to 4 acryloyl groups, and more preferably 2 acryloyl groups in the molecule. For example, the manufacture thereof is performed by a method in which firstly a di-isocyanate and a polyol are reacted in a reaction vessel maintained at 60 to 90° C. and, upon the completion of the reaction, hydroxy(meth)acrylate is added thereto and reacted.

Examples of di-isocyanate include toluene diisocyanate, diphenylmethane diisocyanate, hexamethylene diisocyanate, phenylene diisocyanate, dicyclohexylmethane diisocyanate, xylene diisocyanate, tetramethylxylene diisocyanate, naphthalene diisocyanate, or the like, for example.

Examples of polyol include ethylene glycol, propylene glycol, butanediol, hexanediol, or the like, for example.

Examples of hydroxy(meth)acrylate include 2-hydroxyethyl(meth)acrylate, 2-hydroxypropyl(meth)acrylate, or the like, for example.

The ultraviolet-curing oligomer are preferably present in about 20 to 170 parts by weight, more preferably about 40 to 150 parts by weight relative to 100 parts by weight of the acrylic adhesive. Within this range, a good compatibility with each component of the adhesive described above is maintained, an uneven distribution in the adhesive layer does not occur, and a uniform dispersion is maintained. Then the adhesive layer is suitably cured by ultraviolet irradiation to therefore achieve a desired adhesive force.

The adhesive layer in the adhesive tape or sheet according to the present invention preferably further includes a tackifier. The tackifier may be any known substance. Among these, substances having a hydroxyl value of 120 to 230 mg/g, and more preferably 120 to 210 mg/g are preferred. When the hydroxyl value is too large or too small, insufficient adhesive characteristics prior to ultraviolet irradiation tend to be resulted in relation to the semiconductor wafer or the sealing resin, or the like. Furthermore, the adhesive force after ultraviolet irradiation tends not to reduce to a predetermined value when there is only a small amount of release agent added or attached to the resin surface, or depending on the type of sealing resin or the like in the attachment surface of the adhesive sheet.

The tackifier is preferably present in about 0.1 to 70 parts by weight, more preferably about 1 to 50 parts by weight relative to 100 parts by weight of the acrylic adhesive. Within this range, the adhesive force can be effectively increased, the storage stability of the adhesive sheet can be ensured, and long-term stable performance characteristics can be obtained.

Examples of the tackifier that include the hydroxyl value include terpene phenolic resins, rosin phenolic resins, alkylphenolic resins or the like.

Examples of the terpene phenolic resin include alpha-pinene-phenolic resin, beta-pinene-phenolic resin, dipentene-phenolic resin, terpenebisphenolic resin or the like. When terpene phenol resin is used, high compatibility is achieved in relation to the base polymer in the adhesive. Therefore, there is almost no variation in the adhesive during storage of the tape, and long-term stable quality can be maintained.

The adhesive layer in the adhesive tape or sheet according to the present invention may optionally comprise at least one conventional additive such as softening agents, antioxidants, curing agents, fillers, UV absorbers, photostabilizers, (photo)polymerization initiators and the like. These additives can be used alone or as a mixture of two or more components.

Examples of the softening agent include plasticizer, polybutene, liquid tackifier resins, polyisobutylene lower polymer, polyvinyl isobutyl ether lower polymer, lanolin, depolymerization rubber, processing oil, vulcanized oil or the like, for example.

Examples of the antioxidant include phenol antioxidant such as 2,6-di tert-butyl-4-methylphenol, 1,1-bis-(4-hydroxyphenol) cyclohexane; amine antioxidant such as phenyl β-naphthylamine; benzimidazole antioxidant such as mercaptbenzimidazole; 2,5-di tert-butylhydroquinone, or the like.

Examples of the curing agent for a rubber type adhesive include isocyanate, sulfur-curable and vulcanization accelerator, polyalkylphenol, organic peroxide, or the like. Examples of the isocyanate include phenylene diisocyanate, tolylene diisocyanate, diphenylmetha diisocyanate, hexamethylene diisocyanate, cyclohexane diisocyanate, or the like. Examples of the sulfur-curable and vulcanization accelerator include thiazole rubber accelerator, sulfenic amide rubber accelerator, thiuram rubber accelerator, dithioate rubber accelerator, or the like. Examples of the polyalkylphenol include butyl phenol, octyl phenol, nonyl phenol, or the like. Examples of the organic peroxide include dichromyl peroxide, ketone peroxide, peroxy ketal, hydroperoxide, dialkyl peroxide, peroxyester, peroxy dicarbonate, or the like.

Examples of the filler include hydrozincite, titanium oxide, silica, aluminium hydroxide, calcium carbonate, barium sulfate, starch, clay, talc, or the like.

The photopolymerization initiator is excited and activated by the irradiation of ultraviolet rays, and generates radicals, thereby curing polyfunctional oligomers by radical polymerization. Examples of the photopolymerization initiator include acetophenone compounds such as 4-phenoxy dichloroacetophenon, 4-t-butyl dichloroacetophenon, diethoxyacetophenon, 2-hydroxy-2-methyl-1-phenyl puropane-1-one, 1-(4-isopropylphenyl)-2-hydroxy-2-methylpropane-1-one, 1-(4-dodecylphenyl)-2-hydroxy-2-methylpropane-1-one, 4-(2-hydroxyethoxy) phenyl)-(2-hydroxy-2-propyl) ketone, 1-hydroxycyclohexyl phenyl ketone, 2-methyl-1-[4-(methylthio)phenyl]-2-morpholinoprophane-1; benzoine compounds such as benzoine, benzoine methylether, benzoine ethylether, benzoine isopropylether, benzoine isobutylether, 2,2-dimethoxy-2-phenylacetophenon; benzophenone compounds such as benzophenone, benzoylbenzoate, benzoyl methyl benzoate, 4-phenyl benzophenone, hydroxyl benzophenone, 4-benzoyl-4′-methyldiphenyl sulfide, 3,3′-dimethyl-4-methoxybenzophenone; thioxanthone compounds such as thioxanthone, 2-chlorthioxanthone, 2-methylthioxanthone, 2,4-dimethyl thioxanthone, isopropyl thioxanthone, 2,4-dichloro thioxanthone, 2,4-diethyl thioxanthone, 2,4-diisopropyl thioxanthone; specific photopolymerization initiator such as α-acyloxym ester, acyl phosphine oxide, methylphenyl glyoxylate, benzil, camphorchinone, dibenzosuberone, 2-ethyl anthraquinone, 4′,4″-diethlisophthalophenone, and the like

Examples of the polymerization initiator include peroxides such as hydrogen peroxide, benzoyl peroxide, t-butyl peroxide, or the like. One may be preferably used by itself, or it may be combined with a reducing agent and used as a redox type of polymerization initiator. Examples of the reducing agent include ionic salts such as salts of iron, copper, cobalt, sulfite, bisulfite; amines such as triethanol amine; reducing sugar such as aldose, ketose, or the like. Also, azo compounds such as 2,2′-azobis-2-methylpropioamidine salt, 2,2′-azobis-2,4-dimethylvaleronitrile, 2,2′-azobis-N,N′-dimethyleneisobutylamidine salt, 2,2′-azobisisobutyronitrile, 2,2′-azobis-2-methyl-N-(2-hydroxyethyl) propionamide may be used. These can be used alone or as a mixture of two or more components.

The adhesive tape or sheet according to the present invention can be formed by directly mixing the above components with a solvent as needed, to thereby form an adhesive composition, and then coating or dispersing that composition onto a base.

The mixture of each component is preferably prepared using a propeller stirring mechanism, or a dispersion stirring mechanism, or the like in order to achieve a sufficient and uniform mixture.

There is no particular limitation on the base used in the present invention, and examples may include a conductive metallic foil such as an aluminum foil, a silver foil and the like, or one that is transmissive with respect to ultraviolet rays and/or radioactive rays. Among these, the latter is preferred, and it is preferred that the transmissivity with respect to ultraviolet rays and/or radioactive rays is preferable, for example, at least 75%, at least 80%, and preferably at least 90%.

Examples thereof include one made of a polymer or the like, for example, polyester such as polyvinyl chloride, polyvinylidene chloride, polyethylene terephthalate; polyamide, polyether ether ketone; polyolefins such as low-density polyethylene, liner polyethylene, medium-density polyethylene, high-density polyethylene, very low-density polyethylene, random copolypropylene, block copolypropylene, homopolypropylene, polybutene, polymethylpentene; polyurethane, ethylene-vinyl acetate copolymer, ionomer resin, ethylene-(meth)acrylate copolymer, ethylene-(meth)acrylate (random, alternating) copolymer, ethylene-butene copolymer, ethylene-hexene copolymer, fluorocarbon polymer, cellulosic resin or crosslinked polymer thereof. The base may be either a single layer or a multi-layered structure of two or more layers. The thickness of the base is generally about 5 to 400 μm, preferably 20 to 300 μm.

The base may be surface processed on one side or both sides, for example through surface processing such as corona processing, or the like.

It is preferred that the base in contact with the adhesive layer is processed to achieve electrostatic prevention. There is no particular limitation on the electrostatic prevention processing and, for example, it includes a method in which an antistatic agent is mixed and kneaded into the base and included in the entire base, or by co-extruding the base with the antistatic agent mixed and kneaded therein and including same in at least one layer in the base, or by coating and forming the antistatic agent as an undercoat layer on at least one side, or preferably both sides, of the base.

The method of coating the adhesive composition onto the base, for example, may be any known method such as gravure coating, roll coating, reverse coating, dip coating, flow coating, brush coating, or the like.

After coating, it is preferred to perform thermal drying. The thermal drying may be performed at 80 to 100° C. and for about 30 seconds to 10 minutes.

There is no particular limitation on the thickness of the adhesive layer, and about 1 to 50 μm is suitably applied.

In order to protect the adhesive layer, the adhesive tape or sheet according to the present invention is overlapped with a peeling paper or the like that includes a silicon-processed or fluorocarbon resin-processed layer and that substantially does not adhere to the adhesive layer, on the surface thereof, for example, or is rolled into a rolled product.

The adhesive tape or sheet according to the present invention can be employed in conventionally used methods. For example, the method may be one such that, after adhering and fixing the semiconductor wafer and/or substrate, the semiconductor wafer and/or substrate is cut into small element pieces (chips) by a rotating blade. Thereafter, irradiation with ultraviolet rays and/or radioactive rays is performed from the base side of the adhesive sheet. The wafer-processing adhesive sheet is then expanded (expansion) radially using a designated tool, such that an interval between the small element pieces (chips) is expanded to a fixed interval. Thereafter, the small element pieces (chips) are picked up with a needle or the like, and then the pick-up and mounting are executed simultaneously by suction or the like with an air pin set or the like.

The adhesive sheet according to the present invention can be used with various types of adhesive objects such as semiconductor wafers, semiconductor substrates, sealing-resin substrates or the like in which one or a plurality of chips are individually or integrally sealed using a lead or sealing resin or the like. The adhesive surface of the adhesive object is not limited to a semiconductor, and various inorganic materials such as metals, plastics, glass, ceramics or the like may be used. The adhesive sheet according to the present invention may be particularly used with a structure having a fine unevenness on the surface, i.e. having a surface for attachment that has an unevenness such as a matt-finish structure, or a structure having a surface for adhesion that includes a laser printings r the like, and furthermore may be suitably applied to a structure including a surface for attachment that includes a depression having a depth of 100 μm or less, in at least one position on the surface for attachment.

The examples of the adhesive tape or sheet according to the present invention will be described in detail hereafter. The hydroxyl value of the tackifier is a value induced using a 7.1 neutralization titration method according to JIS K0070-1992.

### EXAMPLE 1

A copolymer (solid component 35%) having a weight-average molecular weight of 800,000 was prepared by copolymerizing 60 parts by weight of methyl acrylate, 10 parts by weight of acrylic acid, and 40 parts by weight of 2-ethylhexyl acrylate.

An adhesive solution was composed and prepared by mixing 100 parts by weight of this copolymer, 100 parts by weight of UV-1700 manufactured by Nippon Synthetic Chemical Industry Co., Ltd. as a multifunction acrylate oligomer, 20 parts by weight of a terpene phenol resin having a hydroxyl value of 160 to 170 KOH mg/g as a tackifier (manufactured as YS Polystar N125 by Yasuhara Chemical Co., Ltd.), 0.5 parts by weight of liquid mixture of a polyalkylene glycol compound and lithium perchlorate (trade name PEL-20A (salt content amount: 10 wt%) manufactured by Japan Carlit Co., Ltd.) (forming a solution by dissolving in ethyl acetate to form a solid component concentration of 10%), 1 part by weight of a polyisocyanate compound as a cross linking agent (trade name “coronate L”, manufactured by Nippon Polyurethane Industry Co., Ltd.), and 3 parts by weight of Irgacure 651 manufactured by Chiba Specialty Chemicals Co., Ltd. as a photo-polymerization initiator.

The resulting adhesive solution was coated onto a polyester film to achieve an adhesive thickness of 20 μm after drying. The polyester film had a thickness of 38 μm and was subjected to silicon peel processing. Drying was performed for five minutes at 120° C.

Thereafter, a 150 μm polyethylene film formed as a base was laminated onto the resulting structure to prepare a semiconductor processing sheet.

The semiconductor processing adhesive sheet obtained was aged at a temperature of 50° C. for at least four days and then evaluated, as will be described below.

### EXAMPLE 2

An adhesive sheet was prepared using the same manner as the Example 1, with the exception that the liquid mixture of the polyalkylene glycol compound and lithium perchlorate (trade name PEL-20A manufactured by Japan Carlit Co., Ltd.) was changed to 3 parts by weight when preparing the adhesive solution.

### EXAMPLE 3

An adhesive sheet was prepared using the same manner as the Example 1, with the exception that the liquid mixture of the polyalkylene glycol compound and lithium perchlorate (trade name PEL-20A manufactured by Japan Carlit Co., Ltd.) was changed to 5 parts by weight when preparing the adhesive solution.

### EXAMPLE 4

An adhesive sheet was prepared using the same manner as the Example 1, with the exception that the liquid mixture of the polyalkylene glycol compound and lithium perchlorate (trade name PEL-20A manufactured by Japan Carlit Co., Ltd.) was changed to 10 parts by weight when preparing the adhesive solution.

### EXAMPLE 5

An adhesive sheet was prepared using the same manner as the Example 2, with the exception that the tackifier was omitted when preparing the adhesive solution.

### EXAMPLE 6

An adhesive sheet was prepared using the same manner as the Example 1, with the exception that the tackifier was changed to 20 parts by weight of a terpene phenol resin having a hydroxyl value of 200 to 210 KOH mg/g (manufactured as Mighty Ace K140 by Yasuhara Chemical Co., Ltd.) when preparing the adhesive solution.

### EXAMPLE 7

An adhesive sheet was prepared using the same manner as the Example 1, with the exception that the liquid mixture was changed to 5 parts by weight of the liquid mixture of a polyalkylene glycol compound and lithium perchlorate/lithium trifluoromethanesulfonate (trade name PEL-25 manufactured by Japan Carlit Co., Ltd.) when preparing the adhesive solution.

### EXAMPLE 8

An adhesive sheet was prepared using the same manner as the Example 1, with the exception that 5 parts by weight of polyether polyol (SANNIX PP-1000, manufactured by Sanyo chemicals inductries) and 1 part by weight of lithium perchlorate were used in stead of the liquid mixture of the polyalkylene glycol compound and lithium perchlorate when preparing the adhesive solution.

### EXAMPLE 9

An adhesive sheet was prepared using the same manner as the Example 1, with the exception that 10 parts by weight of polyether polyol (SANNIX PP-400, manufactured by Sanyo chemicals inductries) and 0.5 parts by weight of lithium perchlorate were used in stead of the liquid mixture of the polyalkylene glycol compound and lithium perchlorate when preparing the adhesive solution.

### EXAMPLE 10

An adhesive sheet was prepared using the same manner as the Example 1, with the exception that the copolymer was changed as follows when preparing the adhesive solution.

A copolymer having a weight-average molecular weight of 700,000 was prepared by copolymerizing 55 parts by weight of ethyl acrylate, 10 parts by weight of acrylic acid, and 35 parts by weight of 2-ethylhexyl acrylate.

### EXAMPLE 11

An adhesive sheet was prepared using the same manner as the Example 1, with the exception that the copolymer was changed as follows when preparing the adhesive solution.

A copolymer having a weight-average molecular weight of 1,000,000 was prepared by copolymerizing 10 parts by weight of methyl acrylate, 55 parts by weight of ethyl acrylate,10 parts by weight of acrylic acid, and 35 parts by weight of 2-ethylhexyl acrylate.

### EXAMPLE 12

An adhesive sheet was prepared using the same manner as the Example 1, with the exception that the liquid mixture of the polyalkylene glycol compound and lithium perchlorate (trade name PEL-20A manufactured by Japan Carlit Co., Ltd.) was varied to 0.333 parts by weight when preparing the adhesive solution.

### EXAMPLE 13

An adhesive sheet was prepared using the same manner as the Example 1, with the exception that 5 parts by weight of polyether polyol (SANNIX PP-1000, manufactured by Sanyo chemicals industries) and 0.076 parts by weight of lithium perchlorate were used in stead of the liquid mixture of the polyalkylene glycol compound and lithium perchlorate when preparing the adhesive solution.

### COMPARATIVE EXAMPLE 1

An adhesive sheet was prepared using the same manner as the Example 1, with the exception that the liquid mixture of the polyalkylene glycol compound and lithium perchlorate was omitted when preparing the adhesive solution.

### COMPARATIVE EXAMPLE 2

An adhesive sheet was prepared using the same manner as the Example 1, with the exception that the liquid mixture of the polyalkylene glycol compound and lithium perchlorate was changed to 0.1 parts by weight when preparing the adhesive solution.

### COMPARATIVE EXAMPLE 3

An adhesive sheet was prepared using the same manner as the Example 1, with the exception that the liquid mixture of the polyalkylene glycol compound and lithium perchlorate (trade name PEL-20A manufactured by Japan Carlit Co., Ltd.) was changed to 20 parts by weight when preparing the adhesive solution.

### COMPARATIVE EXAMPLE 4

An adhesive sheet was prepared using the same manner as the Example 1, with the exception that the copolymer was changed as follows when preparing the adhesive solution.

A copolymer (solid component 35%) having a weight-average molecular weight of 800,000 was prepared by copolymerizing 10 parts by weight of acrylic acid, and 100 parts by weight of 2-ethylhexyl acrylate.

### COMPARATIVE EXAMPLE 5

An adhesive sheet was prepared using the same manner as the Example 1, with the exception that the liquid mixture was changed to 0.3 parts by weight when preparing the adhesive solution.

### COMPARATIVE EXAMPLE 6

An adhesive sheet was prepared using the same manner as the Example 1, with the exception that the liquid mixture was changed to 12 parts by weight when preparing the adhesive solution.

### COMPARATIVE EXAMPLE 7

An adhesive sheet was prepared using the same manner as the Example 1, with the exception that the copolymer was changed to a copolymer obtained by copolymerizing 60 parts by weight of methyl acrylate, and 40 parts by weight of 2-ethylhexyl acrylate when preparing the adhesive solution.

### Tape Adhesion

The adhesive sheet was adhered to a sealing resin surface (of a type having laser printing at a depth of 15 μm on the resin surface) of a substrate mounted on a semiconductor chip, at a table temperature of 45° C. and at a speed of 60 mm/sec using an M-286 adhesion apparatus manufactured by Nitto Seiki Co., Ltd.

After the adhesion, a sample was taken, and the surface potential was measured using an electrostatic potential measurement apparatus (KSD-0103S manufactured by Kasuga Electric Works Ltd.) at a height of 50 mm from the substrate surface.

### Cutting

Cutting was performed using a DFG-651 dicer manufactured by DISCO Corporation using a resin blade having a blade thickness of 300 μm and a rotation speed of 38,000 rpm, under the conditions that a total cutting amount into the base and the adhesive layer is 90 μm, the cutting is performed at a speed of 40 mm/sec, and the water supply amount during cutting is 1.5 L/min.

At this time, in a total of 2000 packages cut into 5 mm square, the number of packages that were broken free was counted.

### Ultraviolet Rays Irradiation for Curing of Adhesive

After the cutting, ultraviolet rays were irradiated for 30 seconds using a 20 mW/cm² high-pressure mercury lamp from the base side to thereby cure the adhesive layer. Thereafter, cooling was performed to room temperature, and the packages were peeled manually. The presence or absence of adhesive residue and the presence or absence of peelability for the 2000 packages was then evaluated.

### Pick-Up Evaluation

After the irradiation with ultraviolet rays, pick-up operations were performed to 200 samples of the packages with a die bonder FED-1780 manufactured by Shibaura Mechatronics Corporation, under the conditions that the pick-up speed is 40 mm/sec, needle height: 500 μm, needle R=500, and the number of needle is one. The number of successful pick-up operations was evaluated.

The results are shown in Table 1 and Table 2.

TABLE 1

| | Example | | | | |
|---|---|---|---|---|---|
| | 1 | 2 | 3 | 4 | 5 |
| Adhesive Forth before | 8.0 | 7.5 | 7.1 | 6.5 | 6.0 |
| UV Ir. to Sub. (N/20 mm) | | | | | |
| Surface Potential of Sub. | 100 V or less | | | | |
| Flying PKG at dicing | 0 | 0 | 0 | 0 | 0 |
| (number) | | | | | |
| Adhesive Forth after UV | 0.38 | 0.35 | 0.30 | 0.25 | 0.22 |
| Ir. to Sub. (N/20 mm) | | | | | |
| Successful Number of | 200 | 200 | 200 | 200 | 200 |
| pick-up | | | | | |
| Adhesive Residue on | no | no | no | no | no |
| Sub. | | | | | |
| | Example | | | | |
| | 6 | 7 | 8 | 9 | 10 |
| Adhesive Forth before | 8.5 | 7.7 | 7.8 | 6.7 | 7.4 |
| UV Ir. to Sub. (N/20 mm) | | | | | |
| Surface Potential of Sub. | 100 V or less | | | | |
| Flying PKG at dicing | 0 | 0 | 0 | 0 | 0 |
| (number) | | | | | |
| Adhesive Forth after UV | 0.4 | 0.32 | 0.32 | 0.22 | 0.29 |
| Ir. to Sub. (N/ 20 mm) | | | | | |
| Successful Number of | 200 | 200 | 200 | 200 | 200 |
| pick-up | | | | | |
| Adhesive Residue on | no | no | no | no | no |
| Sub. | | | | | |

| | Example | | |
|---|---|---|---|
| | 11 | 12 | 13 |
| Adhesive Forth before | 7.8 | 8.3 | 7.8 |
| UV Ir. to Sub. (N/20 mm) | | | |
| Surface Potential of Sub. | 100 V or less | | |
| Flying PKG at dicing | 0 | 0 | 0 |
| (number) | | | |
| Adhesive Forth after UV | 0.32 | 0.38 | 0.32 |
| Ir. to Sub. (N/20 mm) | | | |
| Successful Number of | 200 | 200 | 200 |
| pick-up | | | |
| Adhesive Residue on | no | no | no |
| Sub. | | | |

TABLE 2

| | Comparative Example | | | |
|---|---|---|---|---|
| | 1 | 2 | 3 | 4 |
| Adhesive Forth before | 8.1 | 8.1 | 4.3 | 4.0 |
| UV Ir. to Sub. (N/20 mm) | | | | |
| Surface Potential of Sub. | 2000 V | 1200 V | 100 V or less | |
| Flying PKG at dicing | 0 | 0 | 120 | 250 |
| (number) | | | | |
| Adhesive Forth after UV | 0.55 | 0.45 | 0.18 | 0.12 |
| Ir. to Sub. (N/20 mm) | | | | |
| Successful Number of | 30 | 100 | 200 | 200 |
| pick-up | | | | |
| Adhesive Residue on | 90% | 50% | no | no |
| Sub. | occurred | occurred | | |

| | Comparative Example | | |
|---|---|---|---|
| | 5 | 6 | 7 |
| Adhesive Forth before | 8.0 | 6.4 | 7.0 |
| UV Ir. to Sub. (N/20 mm) | | | |
| Surface Potential of Sub. | 100 V or | 100 V or | 2000 V |
| | less | less | |
| Flying PKG at dicing | 0 | 70 | 200 |
| (number) | | | |
| Adhesive Forth after UV | 0.43 | 0.30 | 1.50 |
| Ir. to Sub. (N/20 mm) | | | |
| Successful Number of | 120 | 200 | 2 |
| pick-up | | | |
| Adhesive Residue on | 40% | no | 90% |
| Sub. | occurred | | occurred |

From tables 1 and 2, in the present examples, during dicing of a semiconductor wafer or the like, prevention of flying wafer can be ensured. Furthermore, in the pick-up step after irradiation with electron beams, no glue residue is found and the operational efficiency can be improved. Furthermore, during the process, static electricity and electrostatic caused by peeling can be reduced and, in addition, circuit failure or product defects in the semiconductor wafer or the like can be reduced.

In the comparative examples as shown, flying wafer occurred. And, during the pick-up step after irradiation with electron beams, glue residue was found. And during the process, static electricity and electrostatic caused by peeling could not be suppressed. In particular, in Comparative Example 7, the compatibility between the adhesive layer and the base is poor and none of the performance characteristics was satisfied.

### INDUSTRIAL APPLICABILITY

The method of manufacturing a semiconductor element according to the present invention has the object of enabling dicing using a water jet laser, i.e. enabling a wide range of applications in relation to all types of materials and not limited to semiconductor-related materials (for example, semiconductor wafers, BGA packages, printed circuits, ceramic plates, glass components for liquid crystal devices, sheet materials, circuit substrates, glass substrates, ceramic substrates, metal substrates, and light-emitting/light-receiving element substrates for a semiconductor laser, a MEMS substrate, or a semiconductor package or the like).

1. An adhesive tape or sheet comprising an adhesive layer which contains
0.3 to 10 parts by weight of an polyether polyol compound, and
0.005 to 2 parts by weight of at least one alkali metal salt
for 100 parts by weight of an acrylic adhesive which is formed with a copolymer of methyl acrylate monomer, ethyl acrylate monomer, or methyl acrylate monomer and ethyl acrylate monomer,
acrylate monomer, and
2-ethylhexyl acrylate monomer.

2. The adhesive tape or sheet of claim 1, wherein the adhesive layer is formed on a base having the transmissivity with respect to ultraviolet light and/or radioactive rays, and further contains at least one ultraviolet-curing oligomer.

3. The adhesive tape or sheet of claim 1, wherein the adhesive layer contains a tackifier having a hydroxyl value of 120 to 230 KOH mg/g.

4. The adhesive tape or sheet of claim 1, wherein the base in contact with the adhesive layer is processed with an electrostatic prevention processing.

5. The adhesive tape or sheet of claim 1, wherein the adhesive tape or sheet is used in an application for a semiconductor wafer or substrate processing.

6. The adhesive tape or sheet of claim 1, wherein the polyether polyol compound has a weight-average molecular weight of 4000 or less.

7. The adhesive tape or a sheet of claim 1, wherein the alkali metal salt is a combination of at least one respective ion selected from a cation comprising of Li, Na, K, Mg, Ca, and an anion comprising of Cl, Br, I, BF₄, PF₆, ClO₄, NO₃, CO₃.
